(19) United States
(12) Patent Application Publication
(10) Pub. No.: US 2014/0090290 A1
(43) Pub. Date: Apr. 3, 2014

(54) PORTABLE BED BUG DETERRENT SYSTEM OF EXPANDABLE AND COLLAPSIBLE LEGS FOR LUGGAGE

(71) Applicant: Robert Baschnagel, III, Garden City, NY (US)

(72) Inventor: Robert Baschnagel, III, Garden City, NY (US)

(21) Appl. No.: 13/631,904

(22) Filed: Sep. 29, 2012

(51) Int. Cl. A01M 1/10

(52) U.S. Cl. 43/123

(57) ABSTRACT

There is disclosed in the present invention a bed bug device comprising a conventional bed bug repellent material formed into an extendable leg which is attached to said bed bug repellent support disk and means for attaching said system to travel luggage, backpacks, etc. as removeably attachable or as a permanent system that comes with said luggage or backpack.

### BACKGROUND OF THE INVENTION

### Field of the Invention

The present invention relates to an insect deterrent device, particularly, a bed bug deterrent device with consists of one or more extendable and collapsible legs structured as such to form a way to prevent insects from getting into one's luggage.

Bed bugs are small insects that feed off the blood of humans and other warm blooded hosts. Bed bug infestation may cause significant itching, and may cause blood-stains on bedding. Recently bed bug infestations are becoming more problematic partially because of increased domestic and international traveling. The term bed bugs is somewhat of a misnomer because these insects are present not only in ones bed but also on carpeting, chairs, couches, rugs, walls, etc. It is very easy for a traveler to come into contact with bed bugs even if they are not exposed to said insects within a bed setting. Bed bugs are able to cling to a traveler's belongings and then be transported with the traveler. As a result, buildings where the turnover of occupants is high, such as hotels, cruise ships, camp dwellings are especially vulnerable to bed bug infestations.

Many attempts have been made to exterminate bed bugs, and they can be divided into two major categories: insecticides and traps. Now more and more people prefer to avoid using hash chemicals in one's home or within a hotel room setting. There is an increased level of resistance to insecticides. The use of insecticides for bed bug control is decreasing. The conventional traps are commonly known as “passive interception devices”. A conventional bed bug trap is often constructed as a chamber formed between an outer and inner rim. Bed bugs are able to climb up them on the outside of the outer rim and then fall into the chamber. The texture on the interior walls of rims, is far smoother and is designed to frustrate the bugs' attempts to crawl up and out again. An example of such design was disclosed in U.S. Pat. No. 427143 to Bauchmuller.

Improvements to conventional bed bug traps have been made to have bed bug attractants in the chamber, either in liquid or power form. The attractants lure the bed bugs into the chamber, thus they function in an active way. Examples for such designs was disclosed in U.S. Pat. No. 57338 to Lake.

Most above mentioned prior arts are applied to the home furniture. Very often, the bed bug traps are attached to the legs of beds. But these traps usually are not conveniently transportable. For travelers, it is difficult to have their luggage, clothing, or belongs protected from bed bugs. Additionally such prior art traps assume there is a post or leg that can be inserted into said trap. Such as the leg of a bed or table. There is no such system where an expandable and collapsible leg is pre attached to the trapping device so as to be used as a stand alone attachment to ones luggage or bags and attached there in for use in a hotel room where fear of bed bugs exists.

If a system could exist that does not concern itself with trapping the bed bugs but just prevent them from getting into ones luggage such a device would be useful during travel. The system describe herein uses the theory that a smooth surface can be created into an expandable and collapsible post and can be used as a leg that extends luggage above the ground and safe from bed bugs crawling into said luggage.

### SUMMARY OF THE INVENTION

In an exemplary embodiment of the present invention, there is disclosed a bed bug deterrent device comprising a variation of a conventional bed bug trap, and an extendable leg. Said device can either collapse into loose portable discs or can extend to keep luggage or bags off the floor. The entire system is made from smooth material that is too smooth for a bed bug to crawl upon. Luggage can be attached to said portable discs so as to turn ones luggage bag into a bag with extension legs that will not allow bed bugs to crawl up said extension legs and into one's luggage bag itself.

The theory of this approach is that bed bugs may or may not be present during one's travels but by using an extension device described herein, one's luggage is safe from infestation by bed bugs.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a fully extended bed bug deterrent device.

FIG. 2 is a cross section of the extended or collapsed device.

FIG. 3 is a collapsed embodiment of said device.

FIG. 4 is a bag with four expanded bed bug deterrent devices attached.

FIG. 5 is a bag with four collapsed bed bug deterrent devices attached to the bottom of said bag.

### DESCRIPTION OF THE PREFERRED EMBODIMENT

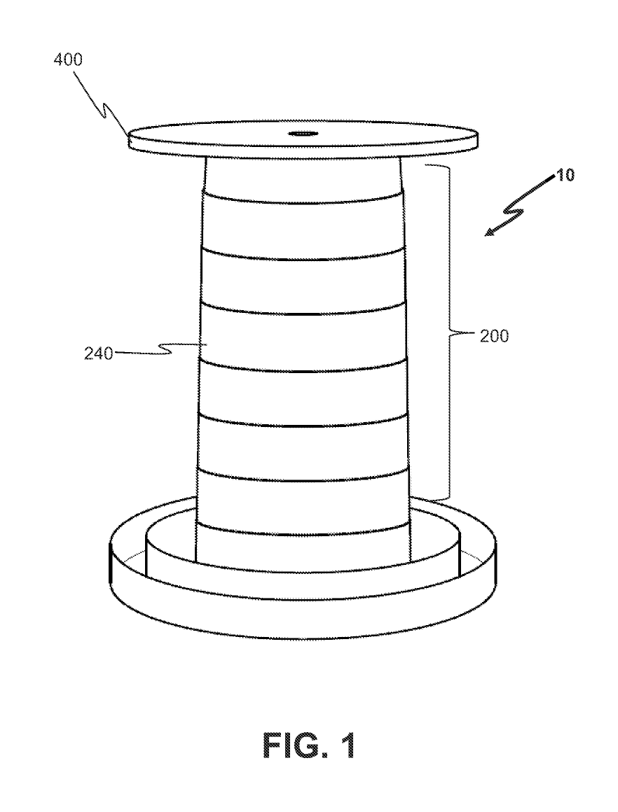

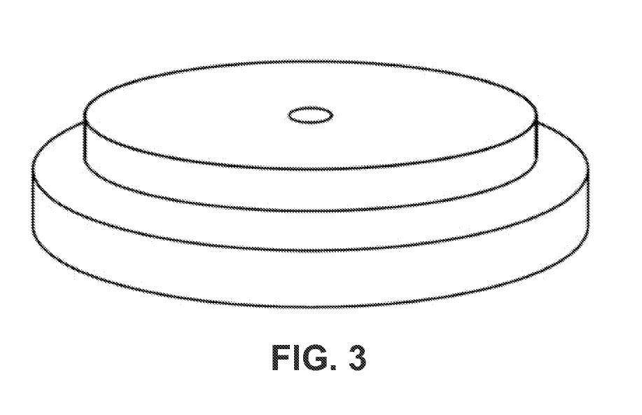

Referring to FIG. 1, there is disclosed a bed bug deterrent device 10 comprising a conventional bed bug trap 100 with completely smooth surfaces where the bugs are unable to attain enough traction to crawl upon its surface, and an extendable leg 200. Said extendable leg 200 comprises several segments 210 that can collapse into portable discs (See FIG. 3). Said device may further comprising a supporting member 400, which is attached to the opposite end of the extendable leg. Luggage or bags, or other belongs of a traveler may be placed on the supporting member, so that said luggage is kept off from the floor, for example, within a hotel room setting.

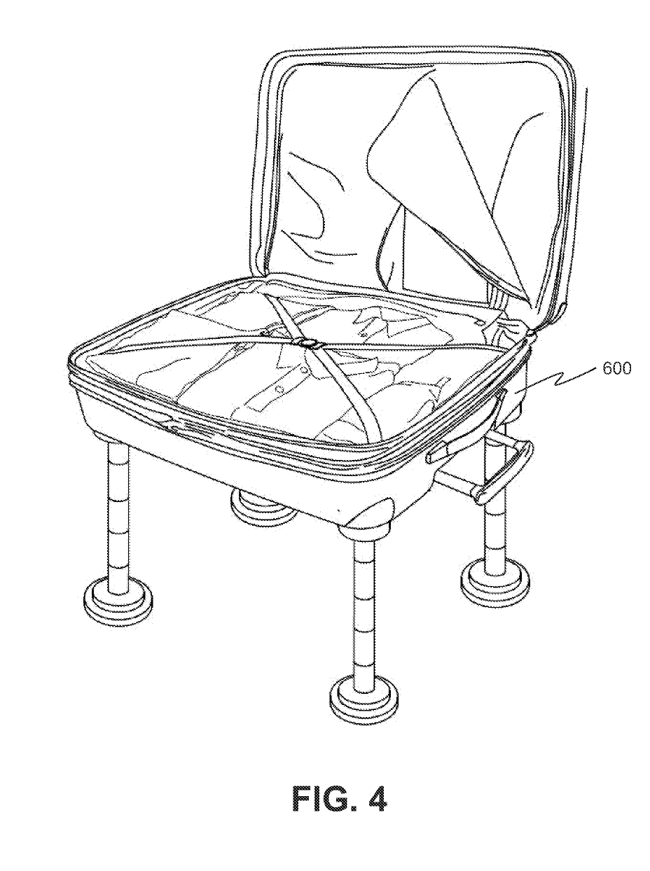

In order to keep said luggage supported four such systems are placed strategically at the four corners of the luggage bag (See FIG. 4) and attached thereon. This can protect luggage, or belongings of a traveler from infestation and from carrying bed bugs from one place to another without awareness of even doing so.

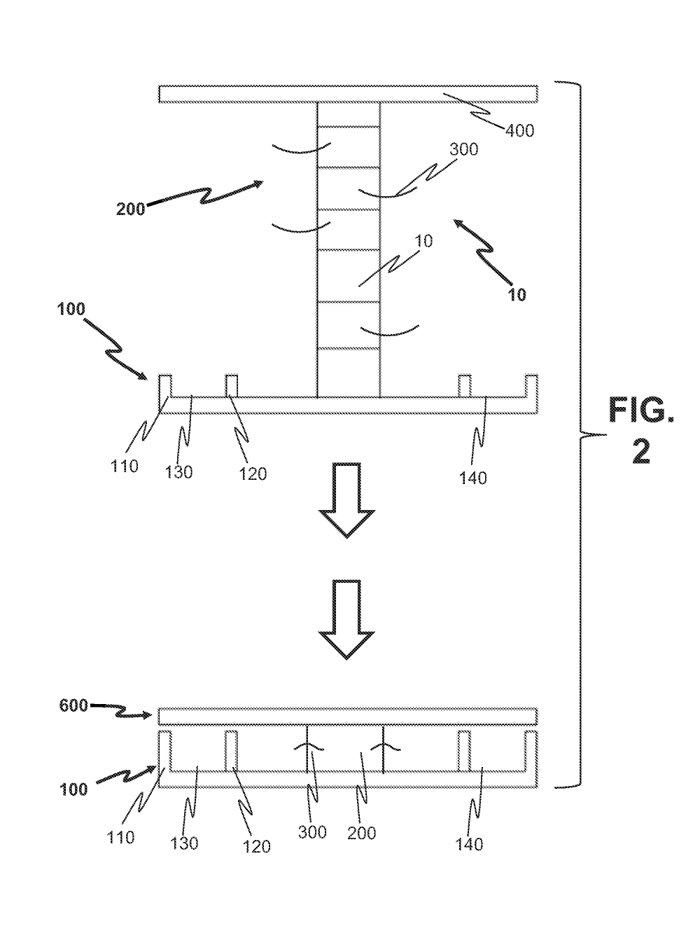

FIG. 2 shows the cross section of an extended device 200 and a collapsed one where sticky material 600 coats upper member 400 allowing for attachment to one's luggage. The extendable leg can collapse and snack together, so that the whole device is portable and easy for travelers to carry. Posts 120, 110, and smooth wells 130 and 140 help ensure bugs will have the inability to reach the upward poll 10 and crawl into one's luggage bag.

FIG. 3. shows a collapsed device as a disk that can be used during transport of attached luggage.

FIG. 4 shows a luggage bag with four deterrent posts attached to said bag by sticky material coating 600 on the surface of the upper end of system when in an extended position.

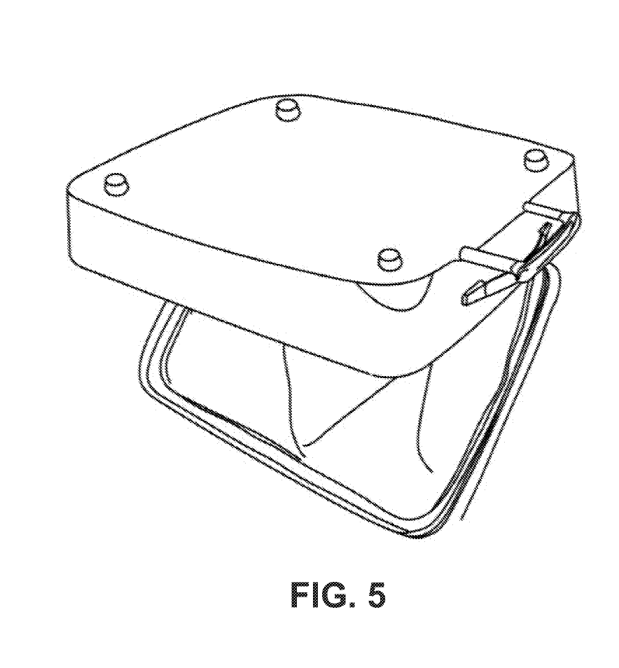

FIG. 5 shows a luggage bag bottom with four deterrent posts attached to said bag in a collapsed position.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A bed bug deterrent device comprising:
i. a bed bug trap;
ii. an extendable leg attached to said bed bug trap; and
iii. an entire surface made of smooth material that is too smooth for a bed bug to crawl upon.

2. A bed bug trap device of claim 1, wherein
i. said bed bug device's surface prevents traction by bed bugs and is comprised of a circular bottom, an outer rim attached to the outer edge of said bottom, and an inner rim attached to inner part of said bottom, wherein said outer and inner rims forming a circular chamber that is with smooth surface too smooth for bed bugs to gain traction and crawl upon;
ii. said extendable lag attached to the center region of said bottom, and said extendable leg may collapse and stack together;

3. A bed bug trap device of claim 2, further comprising a supporting member attached to the other end of extendable leg, and said supporting member can keep items such as luggage or bags up away from floor.
